(19) United States
(12) Patent Application Publication
(10) Pub. No.: US 2009/0089811 A1
(43) Pub. Date: Apr. 2, 2009

(54) Persistent per URL print settings

(76) Inventor: Andrew Rodney Ferlitsch, Camas, WA (US)

Correspondence Address: SHARP LABORATORIES OF AMERICA, INC., 1320 PEARL ST., SUITE 228, BOULDER, CO, 80302, US

(21) Appl. No.: 11/904,405

(22) Filed: Sep. 27, 2007

(51) Int. Cl. G06F 3/12; G06F 15/00; G06K 15/02

(52) U.S. Cl. 719/321; 358/1.15; 358/1.18

(57) ABSTRACT

The present invention improves the economy of repetitively printing Web pages by automatically storing and recalling persistent “per URL” print settings. An exemplary method comprises the steps of receiving from a user a first request to print a web page, selecting by the user print settings for the first request, persistently storing as default print settings for the web page in association with at least a portion of a URL of the web page the print settings selected for the first request, receiving from the user a second request to print the web page and retrieving the default print settings using at least a portion of the URL.

### BACKGROUND OF THE INVENTION

The present invention relates to Web page printing and, more particularly, to improving the economy of repetitive printing of web pages.

Web pages that are subject to frequent changes, such as web pages that track stock portfolios, are often printed repetitively by a user. In such repetitive printing, the user typically wants later print instances of the web page to apply the same print settings that the user selected during an earlier print instance of the web page, but which may differ from default print settings and the print settings of other web pages.

Various general approaches to economize repetitive printing are known. In a first known approach, print settings applied by an application in a first print instance are cached in memory until the application is terminated. If the user of the application makes another print request within the application before the application is terminated, the print settings are initialized to the cached print settings. However, this first approach is limited in that the print settings are initialized to the cached print settings for all subsequent print requests made within the application before the application is terminated, even if the requests are directed to different documents. Moreover, the cached print settings do not persist after the application is terminated.

In a second known approach, a printer driver allows a user to save print settings in persistent storage under a specific name. Once saved, the print settings can be recalled by the user using the specific name and applied to a subsequent print request. However, this second approach is limited in that the user must explicitly save and recall the print settings and remember the specific name under which the print settings were saved.

In a third known approach that is a variation on the second known approach, a print application allows a user to save print settings in persistent storage in relation to document types (e.g. MS-Word, Excel, notepad, etc.). When a user thereafter makes a print request, the print application determines the type of document that is the subject of the print request and initializes the print settings to those saved in persistent storage in relation to the document type. However, this third approach is limited in that the user must explicitly save the print settings. Moreover, the print settings are initialized to the saved print settings for all subsequent print requests of a document type, even if the requests are directed to different documents.

### SUMMARY OF THE INVENTION

The present invention, in a basic feature, improves the economy of repetitively printing web pages by automatically storing and recalling persistent “per Uniform Resource Locator (URL)” print settings.

In one aspect, a computing system comprises a processor and a user interface, wherein under control of the processor print settings selected on the user interface for a first request to print a web page are stored as default print settings for the web page in a persistent storage element in association with at least a portion of a URL of the web page, and wherein under control of the processor in response to a second request to print the web page the default print settings are retrieved from the persistent storage element using at least the portion of the URL.

In some embodiments, the default print settings are stored in further association with an identifier of a printer selected for servicing the first request and are retrieved further using the identifier.

In some embodiments, the retrieved default print settings are presented on the user interface.

In some embodiments, the presented default print settings are modified on the user interface to produce modified print settings and the modified print settings are selected on the user interface for the second request.

In some embodiments, the modified print settings are stored as updated default print settings for the web page in the persistent storage element in association with at least the portion of the URL.

In some embodiments, the print settings selected for the first request are stored in the persistent storage element selectively depending at least in part on a total number of instances in which the print settings have been selected for the web page.

In some embodiments, the computing system is a client node.

In some embodiments, the processor has a printer driver and a web browser executable thereon and the first and second requests are received by the printer driver from the Web browser and processed by the printer driver.

In some embodiments, the web browser identifies the printer driver for processing the first and second requests from among a plurality of printer drivers in response to a selection of a printer on the user interface.

In some embodiments, the processor has a direct submit application executable thereon and the first and second requests are processed by the direct submit application.

In some embodiments, the computing system is a printer node.

In some embodiments, the processor has a print controller executable thereon and the first and second requests are processed by the print controller.

In some embodiments, the processor is on a first node and the user interface is on a second node.

In some embodiments, the processor has a remote controlling application executable thereon.

In another aspect, a method for determining default print settings comprises the steps of receiving from a user a first request to print a web page, selecting by the user print settings for the first request, persistently storing as default print settings for the web page in association with at least a portion of a URL of the web page the print settings selected for the first request, receiving from the user a second request to print the web page and retrieving in response to the second request the default print settings using at least the portion of the URL.

In some embodiments, the default print settings are persistently stored in further association with an identifier of a printer selected for servicing the first request and are retrieved in response to the second request further using the identifier.

In some embodiments, the method further comprises the steps of presenting to the user the retrieved default print settings, modifying by the user the retrieved default print settings to produce modified print settings and selecting by the user for the second request the modified print settings.

In some embodiments, the method further comprises the step of persistently storing as updated default print settings for the web page in association with at least the portion of the URL the modified print settings.

In some embodiments, the persistently storing step comprises persistently storing as default print settings for a web domain of which the URL is a part the print settings selected for the first request.

In some embodiments, the persistently storing step comprises persistently storing as default print settings for the web page and a printer selected for servicing the first request the print settings selected for the first request.

In another aspect, a method for storing default print settings for a web page comprises the steps of selecting a web page for printing, selecting a printer for printing the web page from a plurality of printers, selecting print settings for printing the web page, determining whether default print settings have been stored in association with at least a portion of a URL of the web page from an earlier instance of printing, if default print settings have not been stored in association with at least a portion of the URL from an earlier instance of printing, storing as default print settings in association with at least a portion of the URL and the plurality of printers the selected print settings and if default print settings have been stored in association with at least a portion of the URL from an earlier instance of printing, storing as default print settings in association with at least a portion of the URL and the selected printer the selected print settings.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a networked printing system.

FIG. 2 shows a client node in some embodiments of the invention.

FIG. 3 shows a printer node in some embodiments of the invention.

FIG. 4 shows automatic storing and recalling of persistent “per URL” print settings by a printer driver in some embodiments of the invention.

FIG. 5 shows automatic storing and recalling of persistent “per URL” print settings by a direct submit application in some embodiments of the invention.

FIG. 6 shows automatic storing and recalling of persistent “per URL” print settings by a print controller in some embodiments of the invention.

FIG. 7 shows automatic storing and recalling of persistent “per URL” print settings by a remote controlling print application in some embodiments of the invention.

FIG. 8 shows a method for automatic storing of persistent “per URL” print settings in some embodiments of the invention.

FIG. 9 shows a method for automatic storing of persistent “per URL” print settings in other embodiments of the invention.

### DETAILED DESCRIPTION OF A PREFERRED EMBODIMENT

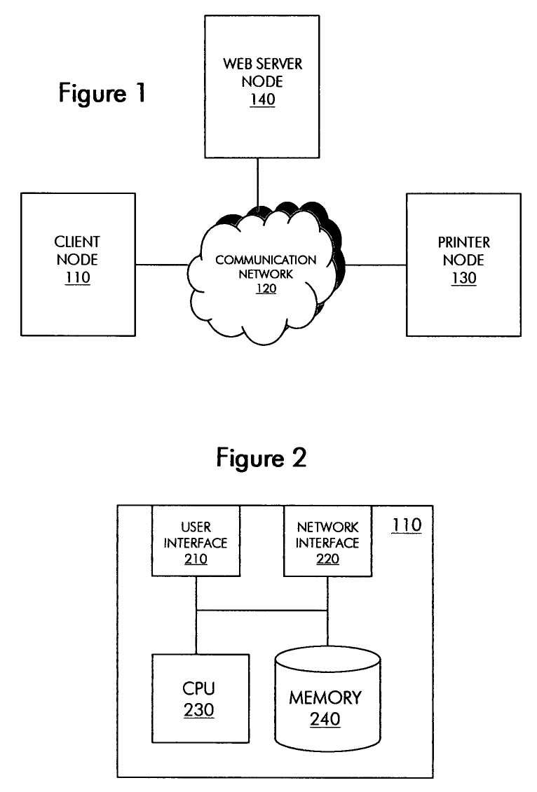

In FIG. 1, a networked printing system is shown in which methods and systems for improving the economy of repetitive printing of web pages are operative in some embodiments of the invention. The printing system includes a client node 110 communicatively coupled with a printer node 130 and a web server node 140 over a communication network 120. Client node 110 is a computing device, such as a personal computer, workstation, cellular phone, personal data assistant (PDA), Internet PC, or cable set-top box (STB), that is capable of receiving on a user interface requests to print web pages downloaded from web server node 140 and generating and transmitting via a network interface, such as a wired or wireless LAN or WAN interface, universal serial bus (USB) interface or cellular interface, print jobs conformant with the requests for outputting on printer node 130. A web page is a hosted document that is addressable using a Uniform Resource Locator (URL) and downloadable, whether via a traditional Internet connection or another consumer, government or academic network connection, such as a cable television connection. Communication network 120 is a data communication network that in a preferred embodiment traverses the Internet and includes one or more LANs, WANs, WiMax networks, ad-hoc networks or other networks each having one or more data communication nodes, such as switches and routers, that operate to communicatively couple client node 110, printer node 130 and web server node 140. In some embodiments, communication network 120 also includes one or more print server nodes that act as intermediaries between client node 110 and printer node 130 in print job processing. Printer node 130 is a computing device having a network interface, such as a wired Ethernet interface, wireless interface or USB interface, that is capable of receiving via a network interface a print job initiated on client node 110, processing the print job and outputting a hard copy of the print job.

In FIG. 2, client node 110 is shown in more detail. Client node 110 has a user interface 210, a network interface 220 and a memory 240 communicatively coupled with a processor (CPU) 230. User interface 210 has an input mechanism, such as a keyboard, keypad, touch-sensitive navigation tool or voice recognition interface for accepting inputs from a user and an output mechanism, such as a liquid crystal display (LCD), light emitting diode (LED) display, cathode ray tube (CRT) or electronic ink (elnk) display for displaying outputs to a user. Network interface 220 is a wired or wireless data communication interface, such as a wired or wireless LAN or WAN interface, USB port or cellular interface, that communicatively couples client node 110 to communication network 120. Memory 240 includes one or more random access memories (RAM) and one or more read only memories (ROM). An operating system installed in memory 240 and executed by processor 230 manages and executes application software on client node 110, such as a web browser and a printer driver or a direct submit application (DSA), which perform various tasks. In some embodiments, these tasks include processing requests received on user interface 210 to print web pages downloaded from web server node 140, determining a printer and print settings appropriate for the print requests and generating and transmitting via network interface 220 print jobs conformant with the requests. Print jobs transmitted in these embodiments may have printer-ready data [e.g. page description language (PDL) data] providing instructions on how text and graphics are to be printed on a page as well as selected print settings. These printer-ready data may be thereafter rasterized on printer node 130 into print engine-ready data for outputting on printer node 130.

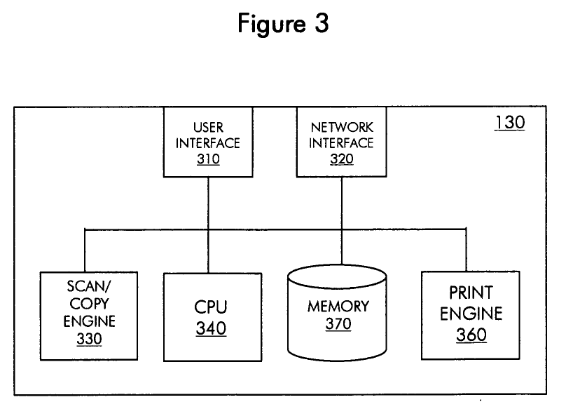

In FIG. 3, printer node 130 is shown in more detail. Printer node 130 in the illustrated embodiment is a multifunction printer (MFP) that supports multiple functions, such as printing, faxing, filing, publishing, format conversion, language translation, scanning and copying. Printer node 130 has a user interface 310, such as a front panel, for accepting inputs from local users and displaying outputs to local users. The user input device may be a keyboard, keypad or LCD touch screen, for example. Printer node 130 also has a network interface 320. Network interface 320 is a wired or wireless data communication interface, such as a wired or wireless LAN or WAN interface or USB port, that communicatively couples printer node 130 to communication network 120. Internal to printer node 130, interfaces 310, 320 are communicatively coupled with a processor (CPU) 340, a scan/copy engine 330, a print engine 360 and a memory 370, which may include one or more RAM and ROM storage facilities. Scan/copy engine 330 includes scanner/copier logic, such as one or more integrated circuits (ICs), and a mechanical section for performing a scanning and copying functions. For example, scan/copy engine 330 may have a line image sensor mounted on a movable carriage for optically scanning a document under the control of a scanner IC and storing the scanned document into memory 370. Print engine 360 includes printer logic, such as one or more ICs, and a mechanical section for performing printing functions. For example, print engine 460 may have a color ink jet head mounted on a movable carriage for printing a document under the control of a printer IC. While in the illustrated embodiments a printer node 130 that supports scanning, copying and printing is shown, in other embodiments of the invention a printer node may support additional or different functions, such as faxing, filing, publishing, format conversion and language translation. In still other embodiments, a single-function imaging device, such as a printer without scanning, copying or foxing capabilities, a fax machine, copy machine or scanning device may be employed. In still other embodiments, an imaging device may be a composite device wherein imaging capabilities are distributed across multiple computing nodes.

Processor 340 manages and executes software on printer node 130, such as print controller software, which performs various tasks. Tasks include processing requests received on user interface 310 to print web pages downloaded from web server node 140, determining print settings appropriate for the print requests and generating print data conformant with the requests. Print data in some embodiments may be converted into an internal print language [e.g. display list (DL) data] providing instructions on how text and graphics are to be printed on a page as well as selected print settings. These print data may be thereafter converted using raster image processing (RIP) into print engine-ready data for outputting by print engine 360. In some embodiments, software executed by processor 340 includes firmware.

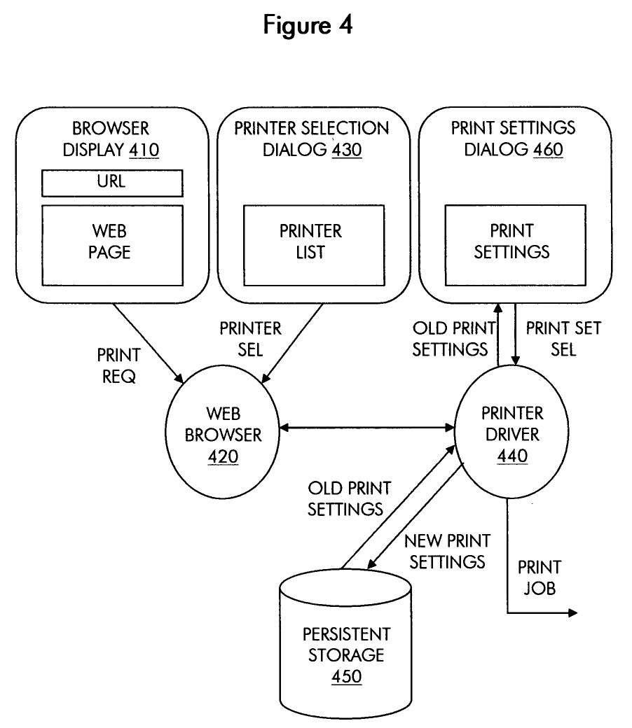

FIG. 4 shows automatic storing and recalling of persistent “per URL” print settings by a printer driver 440 in some embodiments of the invention. In these embodiments, methods and systems for improving the economy of repetitive printing of Web pages are operative on client node 110, which accesses “per URL” print settings in persistent storage 450 that may be retained within memory 240 on client node 110 or externally may be disposed. Persistent storage 450 may be implemented, for example, in a Microsoft system registry, hard drive, non-volatile RAM (NVRAM), database server [e.g. Microsoft Access server, Oracle server, Structured Query Language (SQL) server], storage server, removable storage (e.g. USB thumbdrive), or smartcard.

In operation, a user initiates in a web browser 420 running on processor 230 a request to print a web page downloaded from web server node 140 that the user is viewing in a browser display 410 on user interface 210. In response, web browser 420 presents on user interface 210 a printer selection dialog 430 having a list of printers. The user selects a printer (e.g. printer node 130) from the list and the selection is transmitted to web browser 420. Web browser 420 transmits the print request including the URL of the web page to be printed and an identifier of the selected printer to a printer driver 440, that also runs on processor 230, and that is compatible with the selected printer. Processor 230 may support multiple printer drivers that are compatible with different printers in the list of printers. Printer driver 440 uses the URL and the identifier of the selected printer as a lookup key in persistent storage 450 and retrieves any old print settings, i.e. persistently stored print settings that were selected for earlier print requests directed to the same URL or a URL that shares a common domain name. Printer driver 440 then presents on user interface 210 a print settings dialog 460 displaying the old print settings as default print settings. The user at that point has the option to modify the default print settings to produce new print settings and sends to printer driver 440 an indication to print under the selected print settings. Printer driver 440 invokes Web browser 420 to convert the web page into graphical primitives understood by printer driver 440, such as Microsoft Graphical Device Interface (GDI) primitives, then converts the graphical primitives into a print job compatible with the selected printer and conformant with the selected print settings. Printer driver 440 then transmits the print job via network interface 220 for eventual receipt, processing and outputting by the selected printer (e.g. printer node 130). Additionally, printer driver 440 automatically updates the old print settings stored in persistent storage 450 to conform to the new print settings.

In other embodiments, printer driver 440 uses the web page URL identified in the print request to retrieve old print settings from persistent storage 450 and applies the old print settings to the print job without allowing the user an opportunity to modify the old print settings.

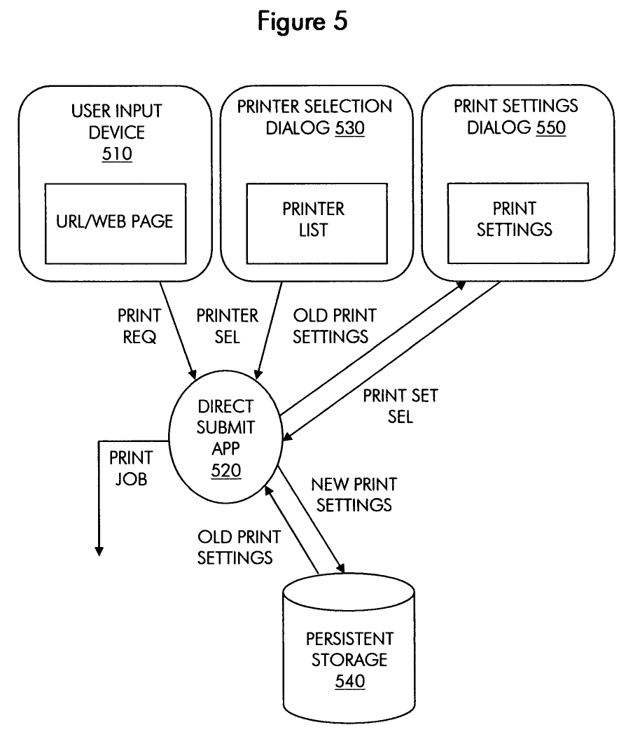

FIG. 5 shows automatic storing and recalling of persistent “per URL” print settings by a direct submit application (DSA) 520 in some embodiments of the invention. In these embodiments, methods and systems for improving the economy of repetitive printing of web pages are operative on client node 110, which accesses “per URL” print settings in persistent storage 540 that may be retained within memory 240 on client node 110 or externally disposed. Persistent storage 540 may be implemented in a Microsoft system registry, hard drive, NVRAM, database server, storage server, removable storage or smartcard, for example.

In operation, a user initiates on a user input device 510 a request to print a web page. The print request identifies the URL of the web page to be printed. In response, DSA 520, which runs on processor 230, presents on user interface 210 a printer selection dialog 530 having a list of printers. DSA 520 may discover printers using various means, such as manual configuration, or auto-discovery using Web Services (WS)-Discovery, Simple Network Management Protocol (SNMP) discovery or Service Location Protocol (SLP). In some embodiments, the user may through user input select a printer that is not on the list. In any event, the user selects a printer (e.g. printer node 130) and the selection is transmitted to DSA 520. DSA 520 then uses the URL and an identifier of the selected printer as a lookup key in persistent storage 540 and retrieves any old print settings, i.e. persistently stored print settings that were selected for earlier print requests directed to the same URL or a URL that has the same domain name. DSA 520 then presents on user interface 210 a print settings dialog 550 displaying the old print settings as default print settings. The user at that point has the option to modify the default print settings to produce new print settings and sends a print indication under the selected print settings to DSA 520. In some embodiments, DSA 520 then downloads the web page from web server node 140 and transmits via network interface 220 the web page contents in a native format [e.g. Hypertext Markup Language (HTML), Cascading Style Sheet (CSS), Extensible Hypertext Markup Language (HTML) or Javascript] along with the selected print settings. If the selected printer (e.g. printer node 130) supports the native format, the transmission may be sent directly to the selected printer for processing and output. If the selected printer does not support the native format, the transmission may be sent directly to a print server or redirected by the selected printer to an external service for conversion prior to being processed and output by the selected printer. In other embodiments, DSA 520 transmits to the selected printer the identified URL and the selected print settings without the web page contents and the selected printer, alone or in combination with a conversion service, is responsible for downloading the web page contents and converting them into a format compatible with the selected printer. Additionally, DSA 520 automatically updates the old print settings stored in persistent storage 540 to conform to the new print settings.

In other embodiments, DSA 520 uses the web page URL identified in the print request to retrieve old print settings from persistent storage 540 and applies the old print settings to the print job without allowing the user an opportunity to modify the old print settings.

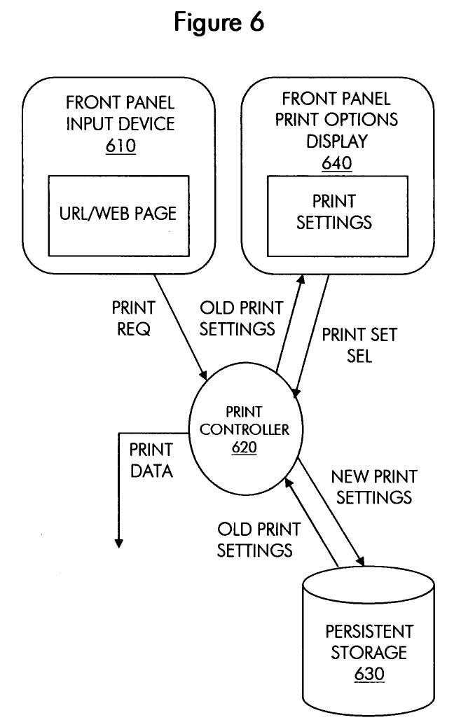

FIG. 6 shows automatic storing and recalling of persistent “per URL” print settings by a print controller 620 in some embodiments of the invention. In these embodiments, methods and systems for improving the economy of repetitive printing of web pages are operative on printer node 130, which accesses “per URL” print settings in persistent storage 630 that may be retained within memory 340 on printer node 130 or externally disposed. Persistent storage 630 may be implemented in a Microsoft system registry, hard drive, NVRAM, database server, storage server, removable storage or smartcard, for example.

In operation, a local user initiates on a front panel input device 610 of user interface 310 a “walkup” request to print a web page. The print request identifies the URL of the web page to be printed. In some embodiments, the user inputs the URL. In other embodiments, printer node 130 supports an embedded web browser within which the user can navigate, display and print Web pages. In still other embodiments, the URL of the web page to be printed may be pre-stored on the printing node 130 and selected by the user. In still other embodiments, the URL of the web page to be printed may be read from an input device, such as a smartcard. In any case, print controller 620, which may be firmware executable by processor 340, uses the URL as a lookup key in persistent storage 630 and retrieves any old print settings, i.e. persistently stored print settings that were selected for earlier print requests directed to the same URL or a URL that has the same domain name. Print controller 620 then presents on user interface 310 a front panel print options display 640 with the old print settings as default print settings. The user at that point has the option to modify the default print settings to produce new print settings and sends a print indication under the selected print settings to print controller 620. In some embodiments, print controller 620 then downloads the web page contents from web server node 140 in a native format [e.g. HTML, CSS, XHTML or Javascript]. In some embodiments, print controller 620 converts the Web page contents into print data [e.g. page description language (PDL) data or DL data] compatible with printer node 130 and conformant with the selected print settings and then applies RIP to convert the print data into print engine-ready data for processing and output by print engine 360. In other embodiments, print controller 620 redirects the web page contents and print settings to an external service for conversion into print data compatible with printer node 130 prior to being processed and output by printer node 130. In still other embodiments, printer node 130 transmits the identified URL and the selected print settings to an external service without downloading the web page contents and the external service is responsible for downloading the web page contents and converting them into print data compatible with printer node 130. The external service may be invoked as a Web service, for example, Web Services for Devices (WSD) print. Additionally, print controller 620 automatically updates the old print settings stored in persistent storage 630 to conform to the new print settings.

In other embodiments, print controller 620 uses the web page URL input by the user to retrieve old print settings from persistent storage 630 and applies the old print settings to the print job without allowing the user an opportunity to modify the old print settings.

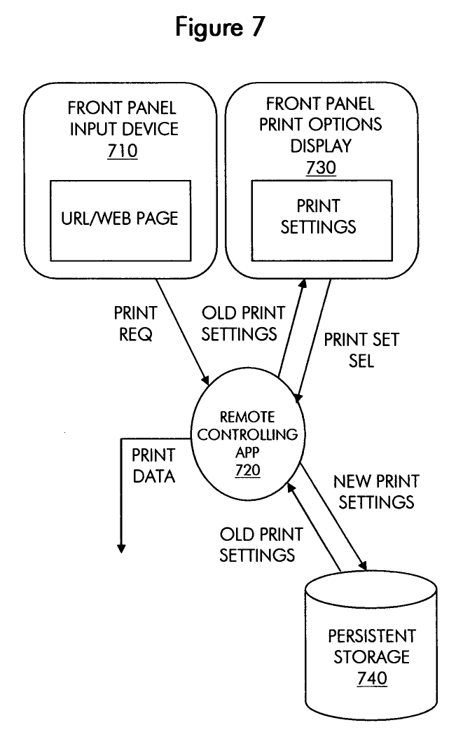

FIG. 7 shows automatic storing and recalling of persistent “per URL” print settings by a remote controlling application 720 in some embodiments of the invention. In these embodiments, methods and systems for improving the economy of repetitive printing of web pages are operative on a remote controlling application 720, such as a Sharp Open System Architecture (OSA) application, that remotely controls printer node 130. Application 720 accesses “per URL” print settings in persistent storage 740 that may be within memory 340 on printer node 130 or externally disposed. Persistent storage 740 may be implemented in a Microsoft system registry, hard drive, NVRAM, database server, storage server, removable storage or smartcard, for example.

In operation, a local user initiates on a front panel input device 710 of user interface 310 a “walkup” request to print a web page. Input device 710 is remotely controlled by application 720 such that all user inputs are delivered to application 720. The print request identifies the URL of the web page to be printed. Application 720, which is executable by a processor on a remote node, uses the URL as a lookup key in persistent storage 740 and retrieves any old print settings, i.e. persistently stored print settings that were selected for earlier print requests directed to the same URL or a URL that has the same domain name. Application 720 then presents on user interface 310 a front panel print options display 730 that displays the old print settings as default print settings. The user at that point has the option to modify the default print settings to produce new print settings and sends a print indication under the selected print settings to application 720. Application 720 then downloads the web page contents from web server node 140 in a native format [e.g. HTML, CSS, XHTML or Javascript]. In some embodiments, application 720 then converts the web page contents into print data (e.g. PDL data) compatible with printer node 130 and conformant with the selected print settings. In other embodiments, application 720 redirects the web page contents and print settings to an external service for conversion into print data compatible with printer node 130. In other embodiments, application 720 transmits the identified URL and the selected print settings to an external service without downloading the web page contents and the external service is responsible for downloading the web page contents and converting them into print data compatible with printer node 130. In any event, application 720 causes the print data to be transmitted to printer node 130 for processing and output. Additionally, application 720 automatically updates the old print settings stored in persistent storage 740 to conform to the new print settings.

In other embodiments, application 720 uses the web page URL input by the user to retrieve old print settings from persistent storage 740 and applies the old print settings to the print job without allowing the user an opportunity to modify the old print settings.

In the client-centric embodiments illustrated in FIGS. 4 and 5, when searching persistent storage 450, 540 with a lookup key for old print settings to present to a user as default print settings or apply directly to a print job, driver 440 and DSA 520 retrieve old print settings that are stored in association with a <URL, printer ID> tuple, if any, that represents the best match with the lookup key. In some embodiments, match quality is ranked as follows: 1) complete URL match for specific printer, 2) complete URL match for all printers, 3) domain name only match for specific printer, and 4) domain name only match for all printers. By way of example, if the URL identified in a print request is http://www.abc.com/help.htm and the selected printer identifier is ACCOUNTING, old print settings stored in association with <http://www.abc.com/help.htm, ACCOUNTING> would be selected over those stored in association with <http://www.abc.com/help.htm, all printers> which would be selected over those stored in association with <http://www.abc.com, ACCOUNTING> which would be selected over those stored in association with <http://www.abc.com, all printers>. Naturally, if there have been no earlier print requests directed to a URL that has at least the same domain name as the current print request, no old print settings will be found in persistent storage 450, 540 for the current print request. Print settings dialogs 460, 550 in that event present the user with default print settings that are not specifically related to the URL identified in the current print request. These default print settings may be preconfigured on client node 110, determined from a printer model database or obtained from the selected printer via a WSD printer profile or Extensible Markup Language Paper Specification (XPS) printer capabilities document, for example.

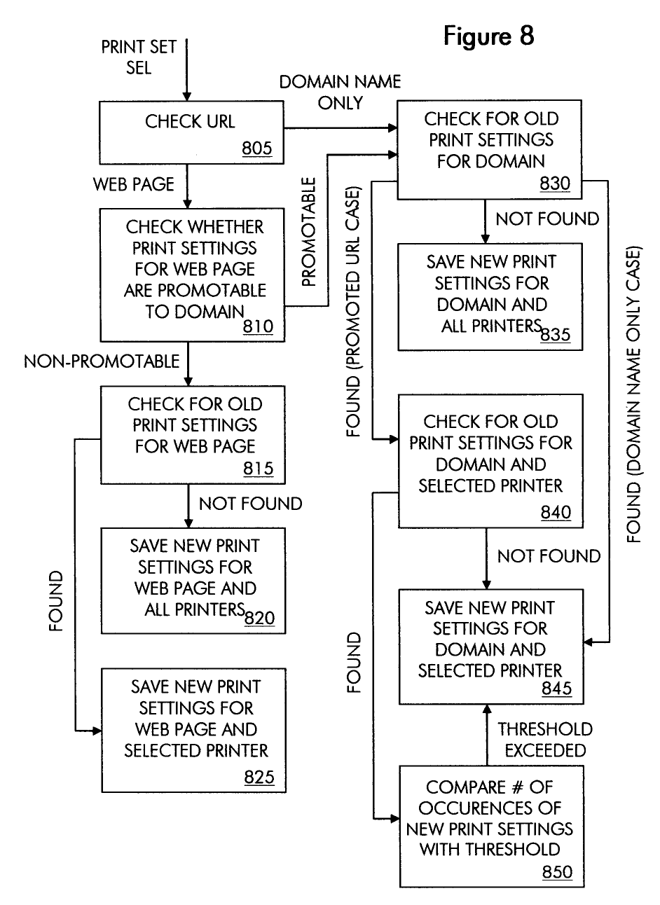

Moreover, to permit selection of default print settings in the manner described in FIGS. 4 and 5, any new print settings selected by a user for application to a current print request are automatically stored in persistent storage 450, 540 for future use in relation to the URL identified in the current print request. FIG. 8 shows a method for automatic storing of persistent “per URL” print settings in the embodiments illustrated in FIGS. 4 and 5. When a user selects new print settings for application to a current print request, that is, print settings that differ from the default print settings presented to the user in print settings dialog 460 or 540, printer driver 440 or DSA 520 checks the URL identified in the current print request (805) to determine if the current print request identifies a domain name only (e.g. <www.abc.com> or a web page within a domain (e.g. <www.abc.com/help.htm>. If the URL identifies a web page within a domain, printer driver 440 or DSA 520 checks whether the new print settings are promotable to the entire domain (810). In this regard, it may be desirable to allow certain web page URLs that are below the level of a domain name to represent the entire domain when selecting default print settings, in which case these certain web page URLs may be promoted. Promotable web page URLs may include web page URLs, for example, that have a specific format. At any rate, if the web page URL is non-promotable, printer driver 440 or DSA 520 checks in persistent storage 450 or 540 for any old print settings that have been stored in relation to the Web page URL (815). If no old print settings are found, printer driver 440 or DSA 520 stores the new print settings in association with the web page URL and all printers (820). If old print settings are found, printer driver 440 or DSA 520 stores the new print settings in association with the web page URL and the printer selected to service the current print request (825).

If the current print request identifies a domain name only, printer driver 440 or DSA 520 checks in persistent storage 450 or 540 for any old print settings that have been stored in relation to the domain name URL (830). If no old print settings are found, printer driver 440 or DSA 520 stores the new print settings in association with the domain name and all printers (835). If old print settings are found, printer driver 440 or DSA 520 stores the new print settings in association with the domain name and the printer selected to service the current print request (845).

If the current print request identifies a promotable URL, printer driver 440 or DSA 520 checks in persistent storage 450 or 540 for any old print settings that have been stored in relation to the domain name of the promotable URL (830). If no such old print settings are found, printer driver 440 or DSA 520 stores the new print settings in association with the domain name and all printers (835). If such old print settings are found, printer driver 440 or DSA 520 checks in persistent storage 450 or 540 for any old print settings that have been stored in relation to the domain name and the printer selected to service the current print request (840). If no such old print settings are found, printer driver 440 or DSA 520 stores the new print settings in association with the domain name and the selected printer (845). If such old print settings are found, printer driver 440 or DSA 520 compares the number of occurrences of the new print settings in association with the domain name and the selected printer since the old print settings were saved against a predetermined threshold (850). If, and only if, the threshold is exceeded, printer driver 440 or DSA 520 stores the new print settings in association with the domain name and the selected printer (845).

In the printer-centric embodiments illustrated in FIGS. 6 and 7, when searching persistent storage 630, 740 with a lookup key for old print settings to present to a user as default print settings or apply directly to a print job, print controller 620 and remote controlling application 720 select old print settings that are stored in association with a URL, if any, that represents the best match with the lookup key. In some embodiments, match quality is ranked as follows: 1) complete URL match, 2) domain name only match. By way of example, if the URL identified in a print request is http://www.abc.com/help.htm, old print settings stored in association with http://www.abc.com/help.htm would be selected over those stored in association with http://www.abc.com. Naturally, if there have been no earlier print requests directed to a URL that has at least the some domain name as the current print request, no old print settings will be found in persistent storage 630, 740 for the current print request. Print settings dialogs 630, 740 in that event present the user with default print settings that are not specifically related to the URL identified in the current print request. These default print settings may be preconfigured on printer node 130, for example.

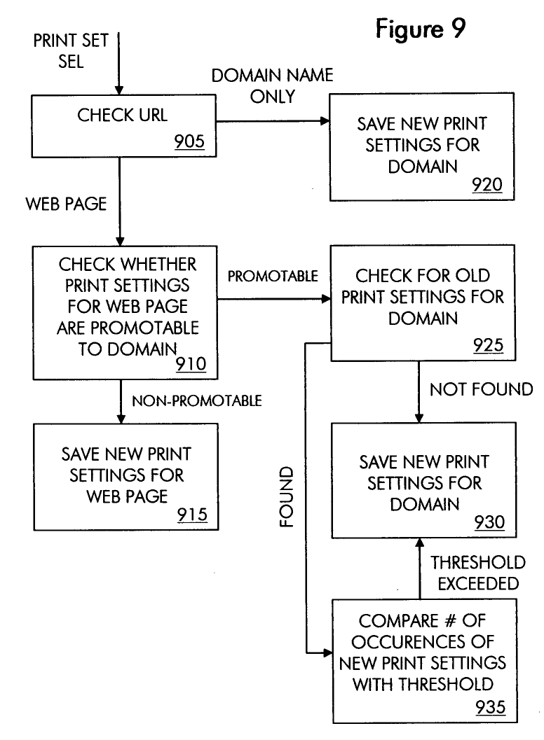

Moreover, to permit selection of default print settings in the manner described in FIGS. 6 and 7, any new print settings selected by a user for application to a current print request are automatically stored in persistent storage 630, 740 for future use in relation to the URL identified in the current print request. FIG. 9 shows a method for automatic storing of persistent “per URL” print settings in the embodiments illustrated in FIGS. 6 and 7. When a user selects new print settings for application to a current print request, that is, print settings that differ from the default print settings presented to the user in front panel print options display 640 or 730, print controller 620 or remote controlling application 720 checks the URL identified in the current print request (905) to determine if the current print request identifies a domain name only (e.g. <www.abc.com> or a web page within a domain (e.g. <www.abc.com/help.htm>. If the URL identifies a web page within a domain, print controller 620 or remote controlling application 720 checks whether the new print settings are promotable to the entire domain (910). If the web page URL is non-promotable, print controller 620 or remote controlling application 720 stores the new print settings in association with the web page URL (915).

If the current print request identifies a domain name only, print controller 620 or remote controlling application 720 stores the new print settings in association with the domain name (920).

If the current print request identifies a promotable URL, print controller 620 or remote controlling application 720 checks in persistent storage 630 or 740 for any old print settings that have been stored in relation to the domain name of the promotable URL (925). If no such old print settings are found, print controller 620 or remote controlling application 720 stores the new print settings in association with the domain name (935). If such old print settings are found, print controller 620 or remote controlling application 720 compares the number of occurrences of the new print settings in association with the domain name since the old print settings were saved against a predetermined threshold (930). If, and only if, the threshold is exceeded, print controller 620 or remote controlling application 720 stores the new print settings in association with the domain name (935).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A computing system, comprising:
a processor; and
a user interface, wherein under control of the processor print settings selected on the user interface for a first request to print a web page are stored as default print settings for the web page in a persistent storage element in association with at least a portion of a Uniform Resource Locator (URL) of the web page, and wherein under control of the processor in response to a second request to print the web page the default print settings are retrieved from the persistent storage element using at least the portion of the URL.

2. The computing system of claim 1, wherein the default print settings are stored in further association with an identifier of a printer selected for servicing the first request and are retrieved further using the identifier.

3. The computing system of claim 1, wherein the retrieved default print settings are presented on the user interface.

4. The computing system of claim 3, wherein the presented default print settings are modified on the user interface to produce modified print settings and the modified print settings are selected on the user interface for the second request.

5. The computing system of claim 4, wherein the modified print settings are stored as updated default print settings for the web page in the persistent storage element in association with at least the portion of the URL.

6. The computing system of claim 1, wherein the print settings selected for the first request are stored in the persistent storage element selectively depending at least in part on a total number of instances in which the print settings have been selected for the web page.

7. The computing system of claim 1, wherein the system is a client node.

8. The computing system of claim 7, wherein the processor has a printer driver and a web browser executable thereon and the first and second requests are received by the printer driver from the web browser and processed by the printer driver.

9. The computing system of claim 8, wherein the web browser identifies the printer driver for processing the first and second requests from among a plurality of printer drivers in response to a selection of a printer on the user interface.

10. The computing system of claim 7, wherein the processor has a direct submit application executable thereon and the first and second requests are processed by the direct submit application.

11. The computing system of claim 1, wherein the system is a printer node.

12. The computing system of claim 11, wherein the processor has a print controller executable thereon and the first and second requests are processed by the print controller.

13. The computing system of claim 1, wherein the processor is on a first node and the user interface is on a second node.

14. The computing system of claim 13, wherein the processor has a remote controlling application executable thereon.

15. A method for determining default print settings, comprising the steps of:
receiving from a user a first request to print a web page;
selecting by the user print settings for the first request;
persistently storing as default print settings for the web page in association with at least a portion of a URL of the web page the print settings selected for the first request;
receiving from the user a second request to print the web page; and
retrieving in response to the second request the default print settings using at least the portion of the URL.

16. The method of claim 15, wherein the default print settings are persistently stored in further association with an identifier of a printer selected for servicing the first request and are retrieved in response to the second request further using the identifier.

17. The method of claim 15, further comprising the steps of:
presenting to the user the retrieved default print settings;
modifying by the user the retrieved default print settings to produce modified print settings;
selecting by the user for the second request the modified print settings; and
persistently storing as updated default print settings for the web page in association with at least the portion of the URL the modified print settings.

18. The method of claim 15, wherein the persistently storing step comprises persistently storing as default print settings for a web domain of which the URL is a part the print settings selected for the first request.

19. The method of claim 15, wherein the persistently storing step comprises persistently storing as default print settings for the web page and a printer selected for servicing the first request the print settings selected for the first request.

20. A method for storing default print settings for a web page, comprising:
selecting a web page for printing;
selecting a printer for printing the web page from a plurality of printers;
selecting print settings for printing the web page;
determining whether default print settings have been stored in association with at least a portion of a URL of the web page from an earlier instance of printing;
if default print settings have not been stored in association with at least a portion of the URL from an earlier instance of printing, storing as default print settings in association with at least a portion of the URL and the plurality of printers the selected print settings; and
if default print settings have been stored in association with at least a portion of the URL from an earlier instance of printing, storing as default print settings in association with at least a portion of the URL and the selected printer the selected print settings.
